(19) United States
(12) Patent Application Publication
(10) Pub. No.: US 2009/0310936 A1
(43) Pub. Date: Dec. 17, 2009

(54) SYSTEM AND A METHOD FOR DOWNLOADING MULTIMEDIA CONTENT AT A TERMINAL

(76) Inventor: Xavier Lebegue, Jouy-En-Josas (FR)

Correspondence Address: Robert D. Shedd, Patent Operations;THOMSON Licensing LLC, P.O. Box 5312, Princeton, NJ, 08543-5312, US

(21) Appl. No.: 12/309,087

(22) PCT Filed: Jul. 4, 2007
(86) PCT No.: PCT/EP2007/056753

§ 371 Date: Jan. 6, 2009

(30) Foreign Application Priority Data
Jul. 7, 2006 (EP) 06300781.9

(51) Int. Cl. H04N 5/91; G06F 17/30; G06F 15/16; G06N 5/02

(52) U.S. Cl. 386/83; 707/10; 707/104.1; 709/203; 706/47; 386/E05.003

(57) ABSTRACT

The present invention concerns a method and system for downloading multimedia content corresponding to a set of program types at a terminal. The method comprises, at a terminal, the steps of filling in a file with a set of program types, sending said file to a server, receiving content corresponding to the file, and receiving said content being regularly updated. Another object of the invention is a method for channel surfing between multimedia content at a terminal. It comprises the steps of downloading content and complementary content according to the previous method, playing the complementary content, receiving a request for channel surfing, checking whether channel surfing is allowed and, if channel surfing is not allowed, continuing playing the complementary content.

The present invention relates generally to a system and a method for providing multimedia content to a terminal, and in particular to a method and system for efficiently managing the distribution of video on demand content to a terminal.

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Numerous systems distribute or present digital video electronically beyond the traditional linear broadcast model. Video on Demand systems, noted VoD, permit an end-user to select a particular content of interest and watch it, usually by paying a per-content premium. Video download systems, possibly using peer-to-peer techniques, allow the end-user to download a video file from a server, typically with a client located in a Personal Computer, and watch the video. There are several platforms that allow this feature: Kontiki, Arvato/GNAB, PeerImpact, 1-Click Media, Djingle. Personal Video Recorders, noted PVR, such as TiVo systems, allow the end-user to select broadcast shows they like, record them, and make them available for viewing on demand. In the viewing phase, the user has to select each show that is to be displayed next. Push boxes, such as Akimbo and MovieBeam, receive premium content and make it available for viewing once downloaded. From the user point of view, this is comparable to VoD, and is also used for high-value content like new movies.

The systems above bring content that is more likely to suit the user than a given broadcast TV channel may, as well as flexibility in program timing. However, all of the systems above require a significant end-user effort in selecting content that should be played next. This effort may be acceptable for an occasional movie, but is questionable for hours of daily TV watching, which tends to be more passive and to contain numerous short programs. Moreover, with the systems above the broadcaster is not able to be ensured that a program is watched by the end-user, since the end-user can skip or fast-forward through the programs. For example, the broadcaster cannot be sure that the end-user has seen advertising-supported content.

The systems above also comprise each some specific disadvantage. The VoD system requires significant investment at the playout as well as at network levels. The video download systems are plagued by download speed or Quality of Service issues. The PVR system only works with material that is broadcast; no <<long tail >> or speciality programming is possible.

The present invention concerns a method and a system for simplifying the reception of VoD content.

In particular it concerns a method for downloading content at a terminal.

To this end, the invention relates to a method comprising, at the terminal, the steps of sending a file comprising a set of program types to a server, and receiving content corresponding to the program types of the file, and receiving subsequent content updates.

According to an embodiment, the step of updating the content comprises a step of updating content that has been played and/or content that has not been played after a delay.

According to an embodiment the method comprises the step of sending a user profile to the server, wherein the file corresponds to the user profile.

According to an embodiment it comprises the step of receiving complementary content, not corresponding to the requested set of program types, and receiving channel surfing rules adapted for managing channel surfing on the complementary content.

According to an embodiment the complementary content corresponds to the user profile and/or the content that has been downloaded.

According to an embodiment the file comprises a timetable adapted to indicate the time when a playlist corresponding to the file is played at the terminal.

According to an embodiment, prior to the step of sending the file, the method comprises a step of filling in the file

According to an embodiment the step of receiving is performed in a peer-to-peer manner.

Another object of the invention is a method for channel surfing between multimedia content at a terminal. It comprises the steps of downloading content and complementary content according to the previous method, playing the complementary content, receiving a request for channel surfing, checking whether channel surfing is allowed and, if channel surfing is not allowed, continuing playing the complementary content.

According to an embodiment the method comprises the step of, if channel surfing is allowed, checking if channel surfing to content corresponding to the file is allowed, and if it is not allowed, playing another complementary content, and if it is allowed, playing content corresponding to the file.

Another object of the invention is device for playing multimedia content. It comprises storing means for storing multimedia content, managing means for defining a file comprising a set of programs, communicating means for sending the file to the server, and for receiving multimedia content, and updates of the multimedia content.

According to an embodiment the device comprises channel surfing means for channel surfing within the content according to rules received from the server.

Another object of the invention is a device for sending multimedia content. It comprises communicating means to communicate to a network comprising at least one client device, storing means for storing multimedia content and user profiles, means for receiving a file comprising a set of program types from the at least one client device, and means for sending content to the at least one client according to the file and/or the user profile.

Another object of the invention is a computer program product comprising program code instructions for executing the steps of the process according to the invention, when that program is executed on a computer. By “computer program product”, it is meant a computer program support, which may consist not only in a storing space containing the program, such as a diskette or a cassette, but also in a signal, such as an electrical or optical signal.

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The invention will be better understood and illustrated by means of the following embodiment and execution examples, in no way limitative, with reference to the appended figures on which:

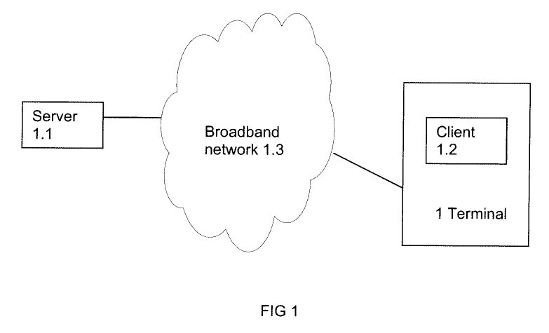

FIG. 1 is a block diagram of a system according to the embodiment;

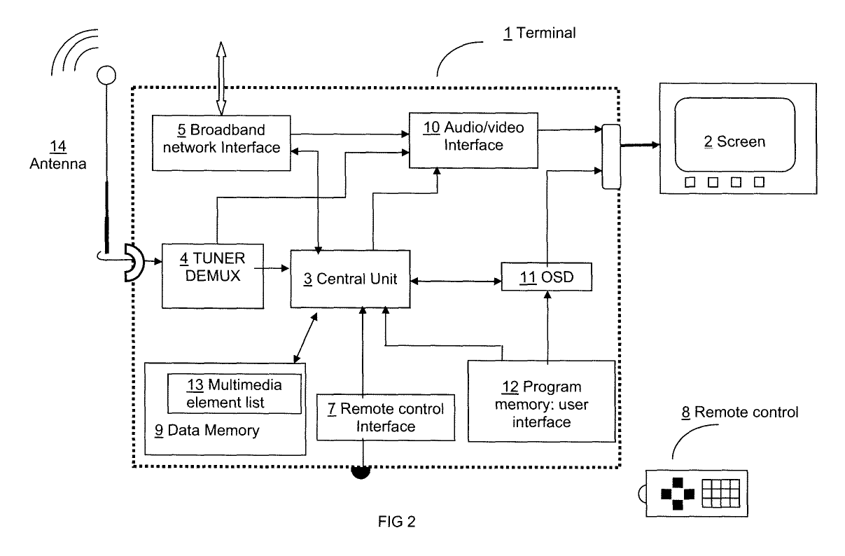

FIG. 2 is a block diagram of a multimedia terminal;

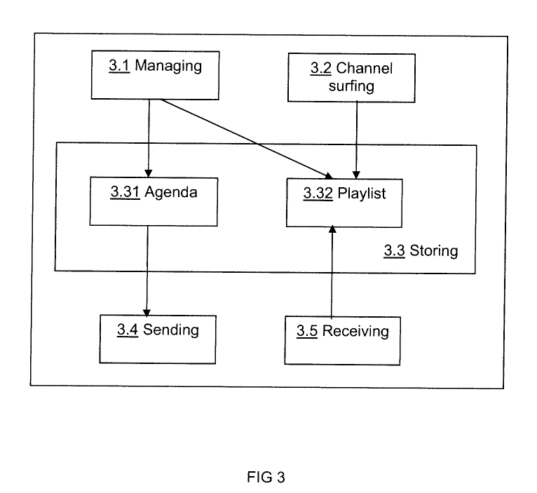

FIG. 3 is another block diagram of the multimedia terminal;

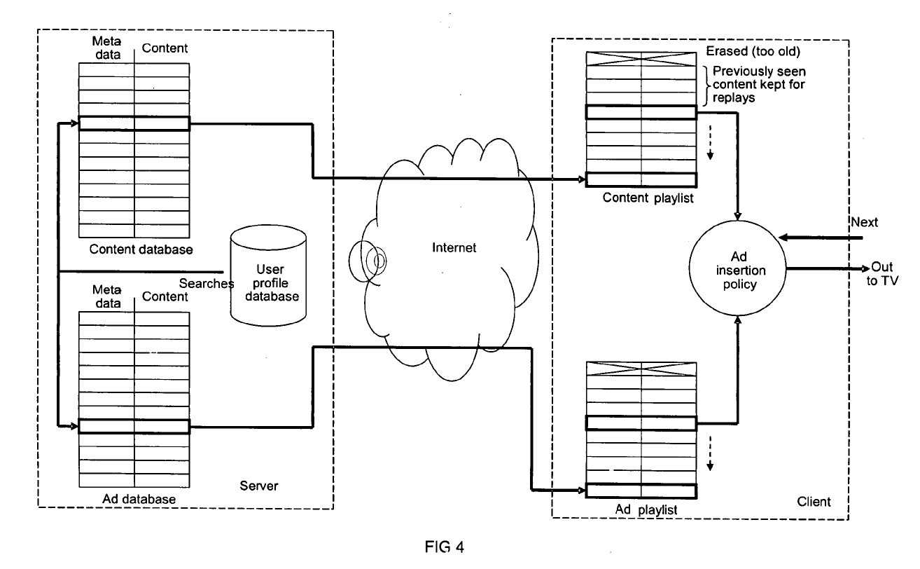

FIG. 4 is a block diagram of the system;

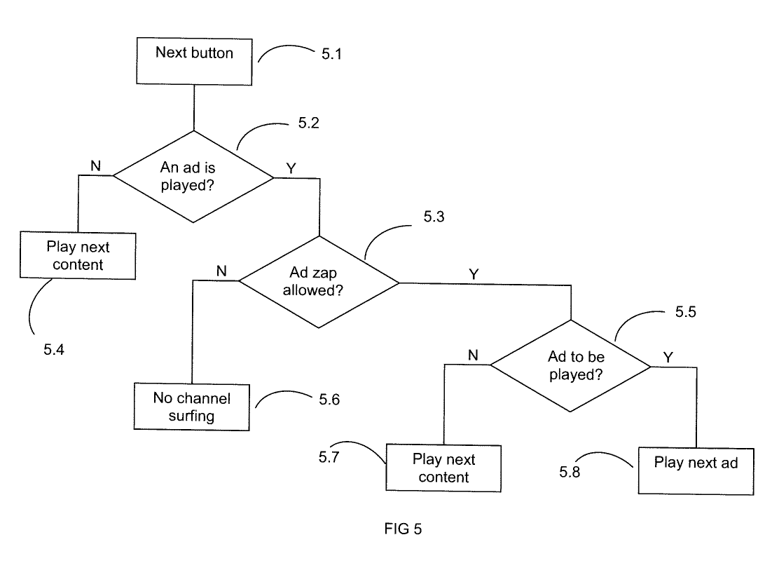

FIG. 5 is a flow chart representing the channel surfing rules; and

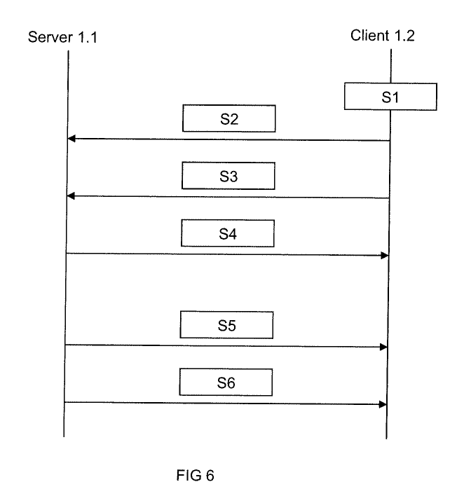

FIG. 6 is a flow chart representing the content distribution.

In FIG. 3, the represented blocks are purely functional entities, which do not necessarily correspond to physically separate entities. Namely, they could be developed in the form of software, or be implemented in one or several integrated circuits.

The exemplary embodiment comes within the framework of a client-server transmission on a broadband network at a set-top-box, but the invention is not limited to this particular environment and may be applied within other frameworks where data are transmitted between two devices.

FIG. 1 is a block diagram of a system according to the embodiment, comprising a server (1.1), a client (1.2) located at a terminal (1), the client and the server being connected through a broadband network (1.3). The broadband network may be any kind of broadband technology, such as digital subscriber line, cable. The broadband network provides a broadband Internet access to the client, and then provides a high data rate connection between the client and the server over the Internet. The server is managed by the broadcaster. The terminal is a set-top-box. It comprises a client that communicates with the server through a client-server protocol, such as HTTP. The connection between the terminal and the server is provided by an Internet Service Provider. This is not a specific broadcast channel reserved on the network for content distribution. This is an internet connection, possibly relying on peer-to-peer file distribution techniques, between the server and the clients. In another words, the content is distributed from the server to the clients, as well as between peers in peer-to-peer in a manner well known per se. In the embodiment as described hereinafter, data is distributed between the server and the client.

According to the embodiment, the terminal receives content that form a program. The content is an audio-video piece; it corresponds to a program type. An agenda is filled in with a plurality of different programs types. It is sent to the server. The server sends content corresponding to the program type to the terminal. The set of content available at the terminal is a playlist.

FIG. 2 is a block diagram of a set-top-box 1, also called a multimedia terminal hereafter, and located at the receiver side, for defining the agenda and receiving the content. FIG. 3 is another representation of the terminal.

The terminal 1 is attached to a visualization screen 2, and comprises a remote control interface 7, for communicating with a remote control 8.

The multimedia terminal also comprises a broadband network interface 5, for connecting to the Internet through a broadband network. With the TCP/IP protocol suite, it can connect to a server located on the Internet and download audio/video content from the server. The terminal connects to a server managed by a broadcaster. It comprises means for sending and receiving data with the server. It may use for example HTTP to perform connection with the server in a client-server manner.

The terminal comprises storing module 3.3 for storing data, a data memory 9, such as a hard disk to store the data received through the broadband network from the server and the peers.

The terminal comprises storing module for storing computer programs that run with a central unit 3 that comprises processing means.

The terminal comprises user interface module 12: this permits the user to manage the terminal, and select the programs he/she wants to watch, as described hereinafter.

The multimedia terminal comprises various means for setting up the mechanism of automatically downloading content and playing it, as described in FIG. 3.

It comprises a management module 3.1 comprising means for creating a selection of program types, called the agenda 3.31. The management module comprises an algorithm that runs with a computer program comprised in a memory of the terminal. The user launches the creation process through the user interface that comprises means for initializing the algorithm. When initialized, a set of screens appears to the user and invite the user to perform the selection. The screens consist of an agenda form and the list of program types available. The user simply selects a program by filling up the agenda with the program types from the list. The list of available program types is downloaded from the server of the broadcaster.

Possibly, the agenda is a calendar and the user fills in the calendar timetable.

The management module 3.1 comprises means for managing the playlist 3.32. The playlist is received from the server. The playlist comprises the set of content that corresponds to the agenda that has been sent to the server. In particular, if the agenda is a calendar, the playlist comprises the content of the coming days, and the one of the past days.

The terminal offers the possibility for the user to view the playlist, and to perform PVR functionalities on the playlist, well known per se: pause, replay recent program, trick modes.

The terminal comprises a channel surfing module 3.2 comprising means for channel surfing within content of the playlist. In particular, even if the playlist corresponds to a timetable, the user is not obliged to watch content according to the timetable. The user may watch any content of the playlist.

The channel surfing means may be set to active and inactive.

Channel surfing rules set up by the broadcaster may be added to the channel surfing means in order to allow the user to zap in the playlist under conditions defined by the broadcaster.

The broadcaster sends an advertisements playlist to the user in addition to the content playlist. In order to be ensured that the user really watches the advertisements, the broadcaster sets up the channel surfing rule as follows. For example when the user zaps to a new content in the playlist, the new content starts with content selected by the broadcaster that the user sees before the new content is played. The new content comes from the advertisements playlist. And the user cannot play the content without having played the advertisements. Channel surfing rules are sent by the broadcaster to the terminal. They comprise the rules for playing the advertisements between the content. The broadcaster may impose the user to watch the advertisements, either by inserting the advertisements in the content and preventing the user from channel surfing to another content, or by playing the advertisements until a pre-defined amount of advertising has been seen by the user.

Channel surfing rules are further depicted in the FIG. 5. The end user presses the next button through the user interface, 5.1. The Ad insertion policy, noted AIP, checks whether this is an advertisement that is played 5.2. If this is not an advertisement, the next content is played 5.4.

If an advertisement is played, the AIP checks whether the channel surfing is allowed between advertisements 5.3. If not allowed, the channel surfing is not performed 5.6, and the advertisement is entirely played. If allowed, the AIP checks whether other advertisement content shall be played 5.5.

If an advertisement shall be played, the next advertisement of the list is played 5.8. If no advertisement should be played, the next content of the list is played 5.7.

Of course the rules defined herein for the advertisement apply to any content that is characterized by the fact that it is imposed to the user by the broadcaster. I.e. it applies to content the broadcaster wants the user to watch.

The terminal comprises a user interface. It permits to manage the agenda, and to visualize the playlist. It permits also the user to select the content in the playlist, and to zap between content.

The terminal optionally comprises means for receiving broadcast program. An antenna 14 attached to a receiving module 4 comprising a tuner, a demodulator and a demultiplexer. The tuner provides the received signal to a demodulator. Received data are corrected and sent to a demultiplexer. The demultiplexer comprises filtering means well known per se. Parts of the audio or video packets filtered by the demultiplexer are stored in redefined areas of the data memory 9. The terminal also comprises a audio/video decoding module 10 for creating the signals that are sent to the screen 2.

A block diagram of the system illustrates the data management in FIG. 4. The server comprises a storing module for storing the user profile database. The user profile database comprises information specific to the user, the user profile, as well as the selection received from the user, the agenda; it also comprises the list of content that has already been sent to the user, in order to avoid sending the same content several times; it also comprises an indication of content that has been viewed by the user.

The server also stores the content database and the advertisement database. The content is organized by program type. For each program type a set of content is available. For example, a cartoon program comprises sub programs for different kinds of cartoons. They are classified by various means such as by the recommended age of the viewer, the heroes of the cartoon.

Each program then comprises a set of content. When the server receives a new profile for a user, it searches content corresponding to the profile and sends the content files to the end user that fits of course to the agenda. Some advertisements may be included in the content by the broadcaster. The advertisements selection may be dependent also on the profile of the end-user, such as the age, the sexual category, some hobbies, or on the profile of the programs selected by the end user. Then two users watching a same content do not necessarily watch the same advertisements. The advertisement is not dependent on the content; it is dependent on the end user.

Of course the user profile, the content and the advertisement database might not be necessary located at the same server.

The database might be shared among several servers. It might also be distributed in a peer-to-peer manner between receivers of the distribution service.

The client side comprises a storing module 9 for storing a content playlist and an advertisement playlist. The content and advertisement playlists are received from the server and the peers. The content playlist comprises the content that has been sent to the user upon selection of programs by the user. This is the content that is made available to the user. It also comprises the content that has already been seen by the user and that is kept for possible replays.

The client also comprises an ads insertion policy module. It comprises the rules for inserting the advertisements into the content and for imposing the advertisements to be played according to the channel surfing rules as defined hereinabove. This module is possibly downloaded from the server. The rules are defined by the broadcaster.

The client comprises management means for managing the playlist. The management comprises, among others, rules for erasing content from the list, rules for keeping content in the list for replay, rules for updating content.

Content is erased from the playlist upon a certain time. For example, the user may choose that all content shall be erased 48 hours after having been seen or uploaded. It may also choose that some content shall be erased after having been seen, or that some other content shall be kept so that it can be seen again.

Content may also be erased even if it has not been seen. For example a program may be the television news of the day. Every day, an updated version of the television news content of the day replaces the old version, even if it has not been seen by the user.

The server regularly updates the playlist in the client. It sends new versions of content. Or, when some content in a program type has been erased from the playlist, the server sends new content corresponding to the same program type.

A client may comprise more than one playlist. A playlist may correspond to a specific user that has been identified. The parents may have their playlist, and a child has its own playlist. The child can not watch and manage the playlist of the parents and the parents can watch and manage the playlist of the child.

Of course each time it is modified, the status of the playlist is indicated to the server. Then, when the user has watched content, the client sends a notification to the server. The server may then send new content corresponding to the same program.

From the terminal side, watching a playlist is functionally the same as watching a broadcast program. Upon its selection, the user watches the programs on the personalized playlist, according to the agenda. It also watches advertisements included by the broadcaster, where channel surfing may not be allowed. The content and the advertisements are downloaded in the terminal automatically based on the agenda.

For example in the case of an agenda corresponding to a calendar, the user has set up an agenda that is the same for all days of the week. This means that it plans for example an episode of a series every day from 6 pm to 7 pm. Every day a new episode is played. If a day the user misses and episode, the next day, the episode that has not been seen is played. If the user has seen the episode, the next day, the following version is played. The user does not have to manage any download for that as it has already specified it in the agenda.

A functional difference with the broadcast delivery is the fact that the user can zap between contents of the playlist. Another difference is the management of the playlist, where the user may miss content one day and see the content later on.

From the terminal side, the method may also be seen as a VoD method. The user terminal downloads content from a server and may see it later on. The difference with a VoD method is the fact that the user terminal downloads a set of content, a playlist, corresponding to a set of program that has been previously defined, instead of one specific content.

In the case of a calendar, the added functionality here is the rule based on the agenda definition and the fact that the content is played and viewed according to the agenda by the end-user.

Also, contrary to VoD mechanism, the playlist comprises content imposed by the broadcaster, that are played at the terminal. The broadcaster imposes rules at the terminal so that the imposed content must be played.

The end user defines the program list as follows. For each end-user, programs of interest are selected in a central database in the server located at the broadcaster side. The selection is based on a combination of self-declared end-user preferences. The selection is based on program types and timetable.

The broadcaster defines a set of well identified program types that the user can select. Examples of program types are cartoon, movie, documentary, television series, information.

The set of program types may be organized into sub-program types. For example within the movie program, there may be a more detailed selection, among western, thriller.

The set of program types also comprises an ‘undefined’ program type that is selected when the end-user does not want to choose a specific program type, and gives the freedom to the broadcaster to choose any program type.

The set of available program types is downloaded to the terminal.

In case of a calendar, the user selects a program among the list, and links the selected program to a timetable.

An example of a timetable is:
cartoons from 6 pm to 8 pm,
30% Western movies, 30% animal documentaries and 40% ‘undefined’ content from 8 pm to 11 pm.

Without a precise selection from the user, the broadcaster may also define a program set among statistics from previous user behavior. For example if the slot 7 pm-8 pm is undefined, the broadcaster may apply a rule defined previously, or apply set the ‘undefined’ program.

The program type list is available to the user at the user interface of the terminal. The user interface also comprises an agenda. For the selection process, the user fills in the agenda with the selected programs. In the case of a calendar, the user may fill in the agenda with well known rules: for example, a program may be defined for a day and be applicable for all days. Or the user may define a different program for each days of the week.

After the selection, the agenda being filled up with a set of program types, the agenda is approved by the user, and sent to the broadcaster through the broadband connection. Of course prior to sending the agenda the user has been authenticated to the server in a manner well known per se. Authentication also comprise sending the user profile to the server.

The agenda is defined at the terminal. Alternatively, the agenda may also be defined from another terminal and sent through a connection to the server. In that case the server also comprises authentication means for identifying the user and allowing the user to define or modify the agenda corresponding to the user profile. The user accesses the agenda through a web page. After modification, the modified agenda is then sent to the terminal by the server, and a matching playlist is also sent to the terminal.

The FIG. 6 is a flow chart summarizing the messages exchanged between the client and the server. At step S1, the client fills in the user profile and the agenda. It authenticates to the server, step S2, and sends the agenda, step S3. It receives the content according to the agenda, step S4. Later it receives complementary content, step S5, and updates, step S6. In FIG. 6, content is received from the server. Of course it can be received from a peer device in a peer-to-peer manner.

At reception of the agenda, the broadcaster builds the playlist to send to the user. The playlist is based on the content available at the broadcaster, and on the user selection. The broadcaster may also impose a program he wants to be watched by the end-user. For each program selected by the user, the broadcaster selects a corresponding content.

Upon a reception of an updated agenda, the server builds a new corresponding playlist that is then downloaded to the terminal.

The embodiment focuses on a set-top-box. Of course it is not limited to a set-top-box and is applicable to any device comprising the means of the device of the embodiment. In particular the receiver might be a cellular device with storing module, and connecting module for connecting to a broadband network. Then, when connected to the broadband network, the terminal downloads and updates the playlist. The user of the terminal may use the playlist, whether the terminal is connected or not to the broadband network. Of course, the channel surfing rules defined hereinabove are applicable to the playlist. The receiver may also be a computer. The computer is connected in the local network to a digital media player, as defined in Digital Living Network Alliance. The digital media player allows displaying the content on a television.

References disclosed in the description, the claims and the drawings may be provided independently or in any appropriate combination. Features may, where appropriate, be implemented in hardware, software, or a combination of the two.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments necessarily mutually exclusive of other embodiments.

Reference numerals appearing in the claims are by way of illustration only and shall have no limiting effect on the scope of the claims.

1-13. (canceled)

14. Method at a terminal, for downloading multimedia content from a server, comprising, at the terminal, the steps of:
Filing an agenda with a set of program types in a timetable;
Sending said agenda to a server,
Regularly receiving an update of a multimedia content corresponding to the program types, and
Storing said multimedia content, said multimedia content being played according to the timetable.

15. Method, according to claim 14, comprising the step of receiving an update of said multimedia content every day, or when said content has been played or after a delay.

16. Method, according to claim 14 wherein the step of sending an agenda comprises the step of sending a user profile to the server said user profile corresponding to said agenda.

17. Method, according to claim 14, comprising the step of:
Receiving complementary content said content being not corresponding to the requested set of program types, and
Receiving channel surfing rules for defining channel surfing on said complementary content.

18. Method, according to claim 17, wherein the complementary content corresponds to the user profile and/or the content that has been downloaded.

19. Device for playing multimedia content, comprising
Managing means for filing an agenda with a set of programs types in a timetable,
Communicating means for sending said agenda to said server, and for regularly receiving an update of a multimedia content corresponding to said program type,
Storing means for storing said received multimedia content; and
Means for playing said multimedia content according to the timetable.

20. Device according to claim 19, wherein communicating means are adapted to receive an update of a multimedia content every days or only when said content has been played or after a delay.

21. Device according to claim 20 comprising channel surfing means for channel surfing within said content according to rules received from the server.

22 Device for sending multimedia content, comprising:
Communicating means to communicate to a network comprising at least one client device,
Storing means for storing multimedia content and user profiles,
Means for receiving a file comprising a set of program types from said at least one client device,
Means for sending content to said at least one client according to said file and/or said user profile.
